(19) United States
(12) Patent Application Publication
(10) Pub. No.: US 2011/0276865 A1
(43) Pub. Date: Nov. 10, 2011

(54) AUTHORING CONTENT IN CONTEXT LOCATION OF BROWSER

(75) Inventors: Tamer E. Abuelsaad, Poughkeepsie, NY (US); Izzac Gonzalez, Poughkeepsie, NY (US)

(73) Assignee: INTERNATIONAL BUSINESS MACHINES CORPORATION, Armonk, NY (US)

(21) Appl. No.: 12/775,545

(22) Filed: May 7, 2010

(51) Int. Cl. G06F 3/01; G06F 17/00; G06F 3/048

(52) U.S. Cl. 715/205; 715/760; 715/810

(57) ABSTRACT

A method is provided and includes sending a set of instructions from a server to a web browser, causing the web browser to identify a set of one or more universal resource locators (URLs) in the set of instructions sent from the server and causing the web browser to add one or more of the identified set of the one or more URLs in a context location of the web browser.

### FIELD OF THE INVENTION

Aspects of the present invention are directed to methods and systems for authoring content in a context location of a web browser.

### BACKGROUND

Most modern web sites are designed to deliver a service or cater to an individual's need and offer a set of key features. For example, most bank web sites allow users to view and update their financial situations at the bank and, in association with doing so, provide account logon or registration links, store locator links, technical support contact links, etc. However with the goal of leaving a lasting impression, some of these modern web sites are designed to attract a user's attention and, in doing so, some simple functionalities (e.g., the reason why the user visited the site) associated with many of the links noted above, among others, become nebulous and are eventually absorbed by the browsing experience that the web site is offering. As a result, users, in particular first-time users, are often left bewildered and at loss for a clear path to his/her specific goal of browsing the web site. On the other hand, web sites that seek to provide simple user functionalities such as, for example, logon, register and searches, are often deemed unattractive and have the potential of losing visitors due to the lack of rich browsing experience that the web site offers.

In view of these competing interests, business owners spend an exorbitant amount of time and money investing in developing and/or revising web sites hoping that the revised web sites strike a right balance between browsing experience and clear web site functionality. This balance is rarely achieved and some users are still left to attempt improving the browsing experience on their own.

Currently, with some web browsers, it is possible for an individual user to modify the web browsing experience of different web sites he visits by way of add-ons, such as the Mozilla FireFox add-on Greasemonkey. Greasemonkey allows a user to inject actions and changes to a web page being rendered by the user's browser. It relies on the user creating JavaScript code, associating it to a specific web site, and triggering the web browser to invoke the script. Thus, Greasemonkey acts as a macro for the user and operates from his point of view but does not represent instructions given by an author of the web site that he visited at all times. In particular, any changes to any of the visited web sites will not be reflected by the user's actions and changes unless the user updates his instructions every time each of the visited web sites is edited by the author of the web site. This is highly impractical and, in any case, is only relevant to the particular user and not to the vast majority of other users who may access the web site. Moreover, Greasemonkey is specific to one platform (FireFox, in this case) and does not represent cross platform standardization.

### SUMMARY

In accordance with an aspect of the invention, a method is provided and includes sending a set of instructions from a server to a web browser, causing the web browser to identify a set of one or more universal resource locators (URLs) in the set of instructions sent from the server and causing the web browser to add one or more of the identified set of the one or more URLs in a context location of the web browser.

In accordance with another aspect of the invention, a method of operation of a web browser of a computing device is provided and includes sending a set of instructions from a server hosting a web site accessed by the web browser to the web browser such that the web browser identifies universal resource locators (URLs) along with information instances associated with each of the URLs and causing the web browser to define the information instances as being respectively associated with each of the URLs and to add the information instances as links to the URLs in a context location of the web browser, which is accessible in response to a command issued by a web browser user.

In accordance with yet another aspect of the invention, a system is provided and includes a server having storage capacity on which a set of instructions are stored, which is configured to send the set of instructions to a web browser, cause the web browser to identify a set of one or more universal resource locators (URLs) in the set of instructions and cause the web browser to add one or more of the identified set of the one or more URLs in a context location of the web browser.

### BRIEF DESCRIPTIONS OF THE SEVERAL VIEWS OF THE DRAWINGS

The subject matter regarded as the invention is particularly pointed out and distinctly claimed in the claims at the conclusion of the specification. The foregoing and other aspects, features, and advantages of the invention are made clear from the following detailed description taken in conjunction with the accompanying drawings in which:

FIG. 1 is a schematic diagram of a system in which a web browser, according to embodiments of the present invention, is operable;

FIG. 2 is a screenshot of a web browser accessing a first web site and being operable in accordance with an embodiment of the present invention;

FIG. 3 is a screenshot of a second accessed web site;

FIG. 4 is a flow diagram illustrating a method of operation of the web browser of FIG. 2 in accordance with embodiments of the invention;

FIG. 5 is a flow diagram illustrating a method of operation of the web browser of FIG. 2 in accordance with other embodiments of the invention; and

FIGS. 6, 7 and 8 are exemplary screenshots of a content menu, a browser menu and browser real estate, surface area and/or a browser container/canvas, respectively.

### DETAILED DESCRIPTION

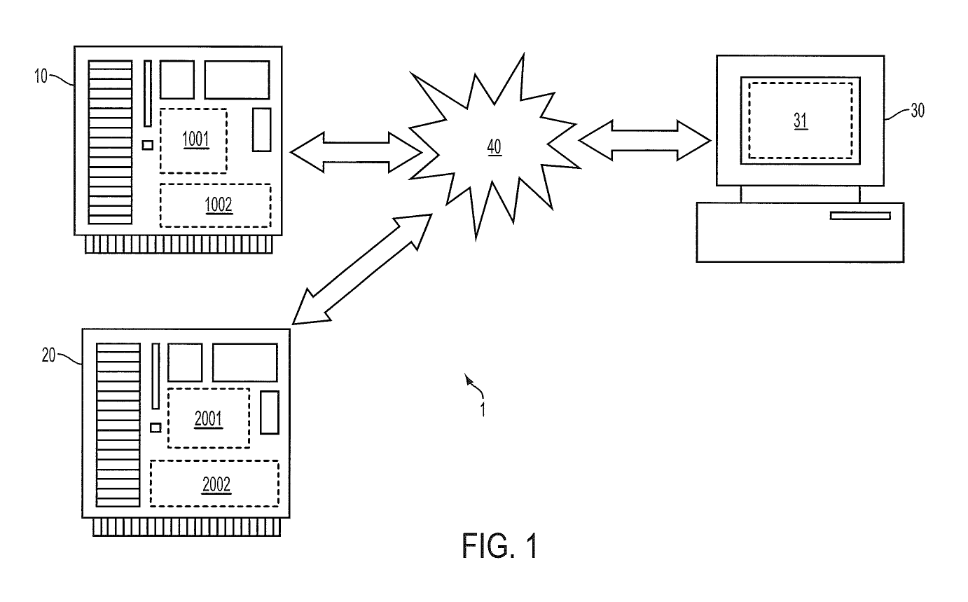

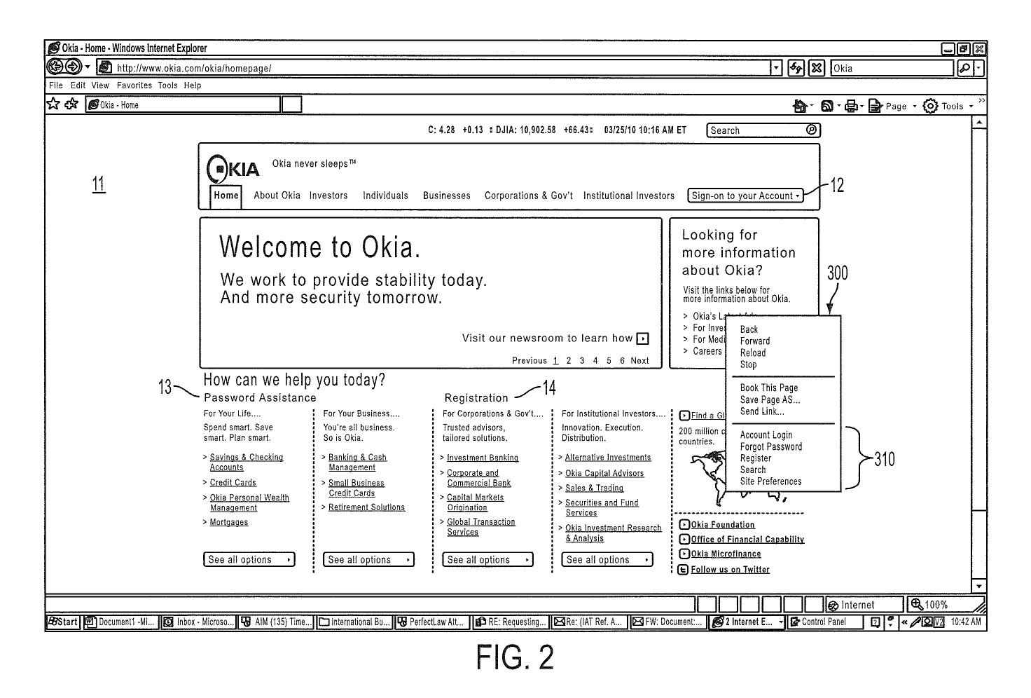

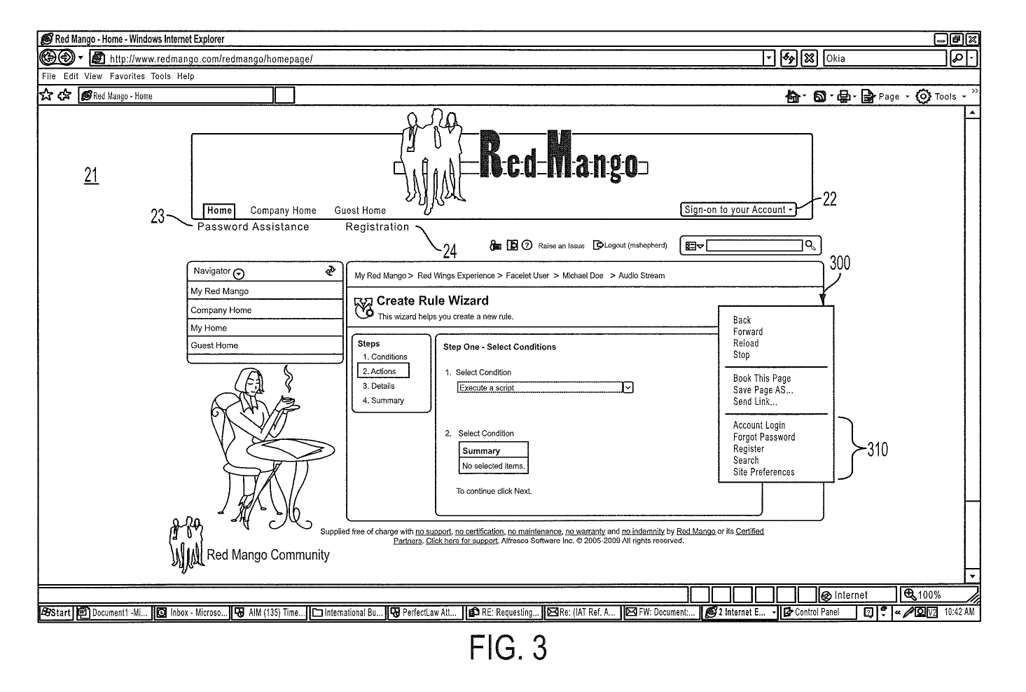

With reference to FIGS. 1-3, a system 1 is provided in which at least first and second servers 10 and 20 host at least first and second web sites 11 (see FIG. 2) and 21 (see FIG. 3), respectively. The web sites 11, 21 are each accessible by an end user using a client, such as a computing device 30, via the Internet 40 or some other similar network or communication media. Each of the servers 10, 20 may be administered by their respective web site authors or designers who design, encode and maintain the web sites 11, 21 for associated businesses. The end user accesses those web sites using a web browser 31, such as Internet Explorer or Safari, installed on the computing device 30 in order to view and/or participate in services provided by those businesses.

As shown in FIGS. 2 and 3, the services provided by each business via the web sites 11, 21 may be similar or may vary. In either case, each of the web sites 11, 21 include links that facilitate access to those services. The purposes of these links are often similar among various web sites regardless of the type of web site being accessed. They include, but are not limited to, account login links 12, 22, password assistance links 13, 23 and registration links 14, 24. These links can be clicked by the end user so as to direct the web browser 31 to render a page associated with the universal resource locator (URL) of each link.

Respective functionalities of the web sites 11, 21 are thus at least partially related to the ease by which an end user locates the links. The browsing experience can be diminished if the importance of functionality takes precedence over any other web design considerations to the extent that the links become the dominant graphic features of the web sites 11, 21. Thus, since each business weighs the need for functionality differently against the desire for a pleasant browsing experience, the account login links 12, 22, the password assistance links 13, 23 and the registration links 14, 24 are each positioned in different regions of the web sites 11, 21, respectively, even though they may direct the end user to similar types of pages.

As a result, an end user may access web site 11 in order to click on the password assistance link 13 and, when he accesses web site 11, he is first required to locate link 13. Thereafter, if the end user accesses a different web site such as web site 21, he is required to again locate a new link 23 in order to access the password assistance functionality. In accordance with aspects of the present invention, the user's time spent searching for links 13 and 23 may be significantly reduced and/or saved and functionality of web sites 11, 21 be improved without sacrificing browsing experiences.

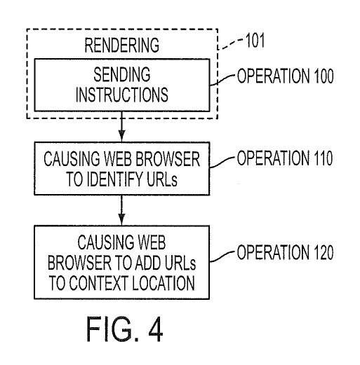

With reference to FIG. 4, and in accordance with one aspect of the invention, a method of automatic operation of the web browser 31 is provided. The method includes sending a set of instructions from a server, such as the first server 10, to a web browser, such as web browser 31 (operation 100), causing the web browser to identify a set of one or more universal resource locators (URLs) in the set of instructions received (operation 110), and causing the web browser to add one or more of the set of the one or more URLs in a context location 300 of the web browser 31 (operation 120), as being illustrated in FIG. 2 and FIG. 3.

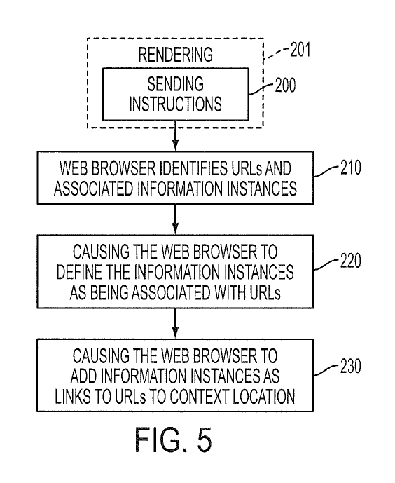

With reference to FIG. 5 and, in accordance with another aspect of the invention, a method of automatic operation of the web browser 31 is provided. The method includes sending a set of instructions from a server, such as first server 10, which hosts the web site 11 that is accessed by the web browser 31 to the web browser 31 (operation 200) such that the web browser 31 is caused to identify universal resource locators (URLs) along with information instances associated with each of the URLs in the set of instructions received (operation 210), causing the web browser 31 to define the information instances as being respectively associated with each of the URLs (operation 220) and causing the web browser 31 to add the information instances as links 310 to the URLs in a context location 300 of the web browser 31, as being illustrated in FIG. 2 and FIG. 3, which is accessible in response to a command issued by the end user (operation 230).

In accordance with the methods of FIGS. 4 and 5, the automatic operation of the web browser 31 refers to the fact that an end user is not required to take any action or to input any commands in order to cause the set of the instructions to be received or acted upon by the web browser 31. As such, an author of web site 11 or 21 can embed certain instructions, being transmitted to the web browser 31 from the servers 10 or 20 via internet 40 or other transmission media, in the web site 11 or 21 at a predefined time without additional instruction provided by the end user. The web browser 31 then renders graphics associated with these instructions to provide the context location 300 to the end user in response to, e.g., a user action or command with respect to the web browser 31. The context location 300 for the web site 11 may subsequently include the links 310, including links similar to links 12, 13 and 14 that the user would otherwise have had to spend time searching for. By the same token, the context location 300 for the web site 21 may subsequently include the links 310, including links similar to links 22, 23 and 24 that the user would otherwise have had to spend additional time searching for.

Links 12, 13, and 14 may be similar to links 22, 23, and 24 or may be different. The number of, and types of, links being added to context location 300 may be independently determined by authors of each different web site such as web site 11 or web site 21, which may be based upon different business needs. Method of access to the context location 300 by an end user may be pre-determined by the type of web browsers installed in computing device 30, such as web browser 31, and such features of pre-determined methods of accessing a particular context location may be standardized or made uniform across different web browsers, according to embodiments of the present invention.

The sending of operations 100 and 200 may occur at any time during which the web browser communicates with the servers 10, 20. In some embodiments, the sending of operations 100 and 200 occurs during the rendering 101, 201 of the hypertext markup language (HTML), the extensible markup language (XML) or any other similar programming language of the web sites 11, 21 when the web browser 31 accesses those web sites 11, 21. The instructions may then be associated with each of the web sites and stored so that the next time the web browser 31 accesses the web sites 11, 21, the receiving operations 100 and 200 can be skipped but for updates when available. If the instructions are not stored, it is understood that the receiving operations 100 and 200 may be repeatable.

In the methods of FIGS. 4 and 5, the set of the one or more URLs is communicated from the server 10 to the web browser 31 through, for example, an HTML or an XML tag, such as a meta tag, specifying content to be placed in the context location, although it is understood that these are merely exemplary examples and that other programming languages, scripting, markup languages, etc. may be used. That is, upon the rendering 101, 201 (or at any point during the communications between the web browser 31 and the servers 10 and 20) of the web page, the web browser 31 may detect markups, meta tags and/or tags that signal the presence of HTML links, such as URLs, that will be placed in the context location 300. Such markups, meta tags and/or tags may be pre-defined by web browser 31 for easy detection. Examples of such meta tags may include, but not limited to:

<meta name=“others” content=“Account Login: http://mysite.com/login”/>
<meta name=“others” content=“Forgot Password: http://mysite.com/login/forgot”/>
<meta name=“others” content=“Register: http://mysite.com/newaccount”/>
<meta name=“others” content=“Search: http://mysite.com/search”/>
<meta name=“others” content=“Site Preferences: http://mysite.com/prefs”/>

The use of meta tags or other similar indicators allows the web browser 31 to be operable, configured or otherwise programmed to provide a customized context location 300 to an end user. By way of the meta tags, the web browser 31 is configured to examine data received from the servers 10, 20, to identify the presence of, e.g., HTML links to certain URLs, to place certain content in the context location 300 and to parse information to render the context location 300.

In accordance with embodiments, meta tags are merely an exemplary one of the ways that the authors of the web sites 11, 21 can indicate to the web browser 31 content that is to be placed in the context location 300. Indeed, methods other than meta tag specification can also be used to provide this signaling to the web browser 31.

In some embodiments, the adding of the information instances of operation 230 may include adding the information instances as hyperlinks in the context location 300. As such, a user action, such as a left-click, may open a new browsing window of the web browser 31 accessing the URL of the linked information instances. Alternatively, the user action may open up new web browser 31 tabs. As yet another alternative, the user action may render the URL of the linked information instances in the currently open and active web browser 31 window.

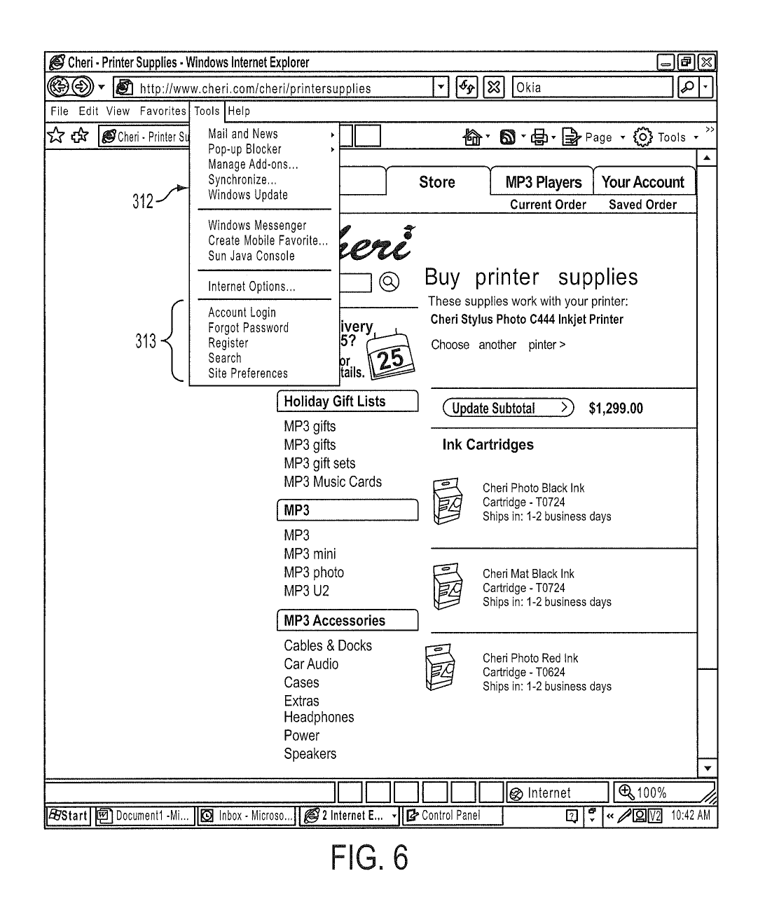

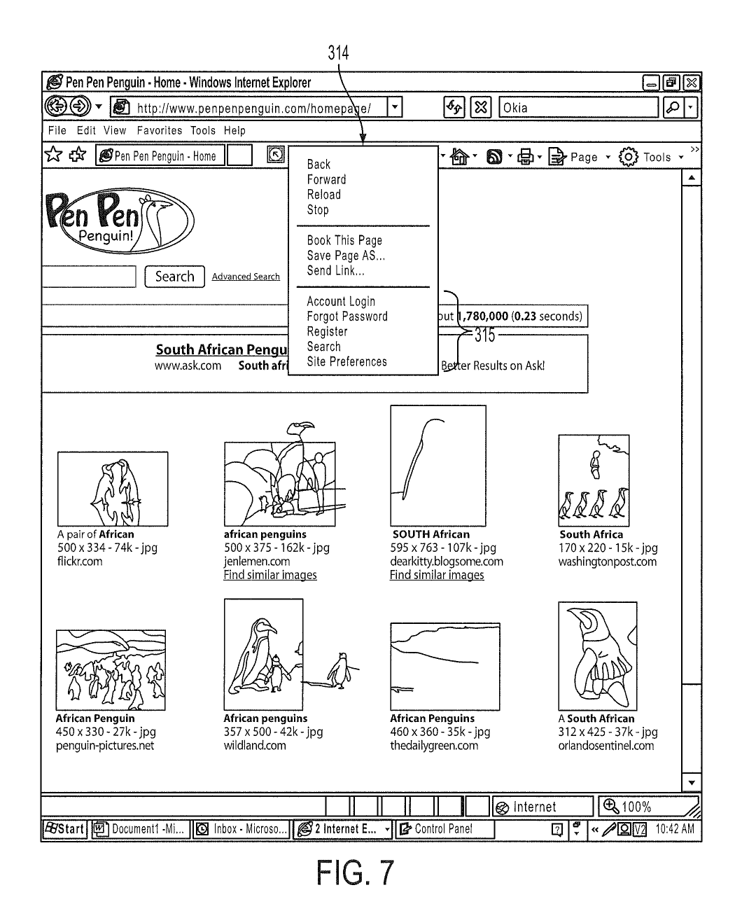

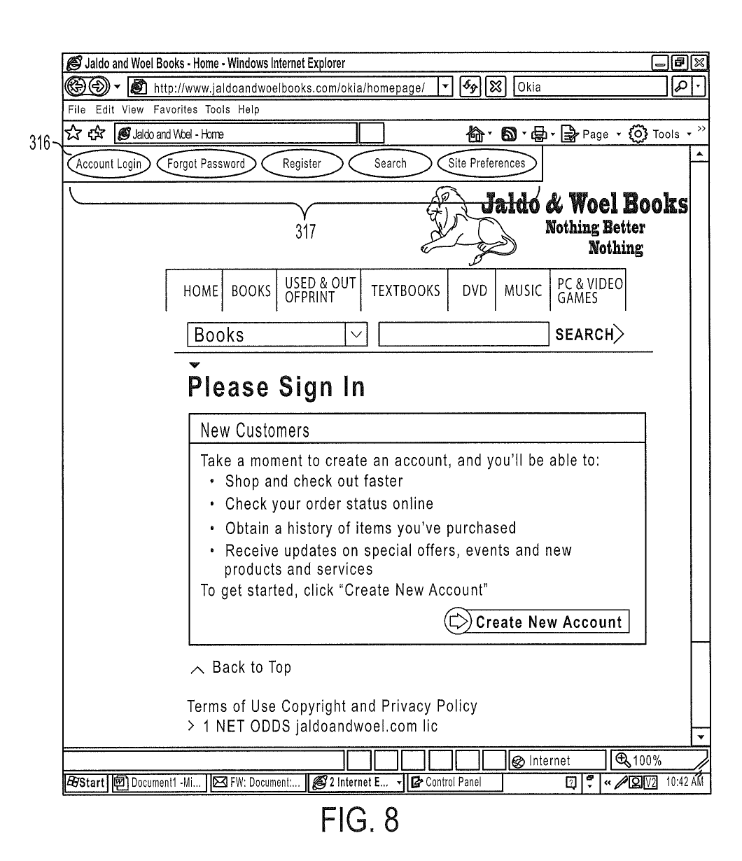

With reference to FIGS. 6, 7 and 8, the types of the context location 300 may include, for example, a browser menu 312 including menu options 313 as shown in FIG. 6, a content menu 314 including menu options 315 as shown in FIG. 7, or some other similar graphic features. These graphic features may include or further include browser real estate, surface area and/or container canvas 316 including positions 317, as shown in FIG. 8, which are displayable in the browsing window of the web browser 31. In any case, the context location 300 is accessible by a user action relative to the web browser 31. For example, the context location 300 may be accessed by scrolling over it with a mouse and/or may be right-click accessible in any part of the web browser 31 browsing window and may include a pull-down menu or a scrolling window the user can operate with the mouse or a keyboard. As a further example, hot keys or other similar devices may be employed to allow an end user to access the context location 300.

In accordance with further embodiments of the invention, the set of instructions may include a first set of instructions, the server 10 may be a first server 10 and the set of the one or more URLs may be a first set of the one or more URLs. Here, the method may further include sending a second set of instructions from a second server 20 to the web browser 31 (similar to operation 100), causing the web browser to identify a second set of one or more URLs in the second set of instructions (similar to operation 110) and causing the web browser 31 to replace at least one of the first set of the one or more URLs with at least one of the second set of the one or more URLs in the context location (similar to operation 120). The first server 10 and the second server 20 may be separate devices or may be incorporated in a shared device. As such, where the context location 300 of web site 21 has only link 310 that is different from that of web site 11, all the links 310 or only that one link 310 may be modified.

In accordance with further aspects of the invention, a non-transitive machine-readable storage medium 1001, 2001 (see FIG. 1) is provided for use with a computing device including a processing unit 1002, 2002 (see FIG. 1) and a storage unit on which the machine-readable storage medium is stored. The machine-readable storage medium may have executable instructions stored thereon, which, when being executed, causes the processing unit of the computing device to execute the methods as being described above.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A method, comprising:
sending a set of instructions from a server to a web browser;
causing the web browser to identify a set of one or more universal resource locators (URLs) in the set of instructions sent from the server; and
causing the web browser to add one or more of the identified set of the one or more URLs in a context location of the web browser.

2. The method according to claim 1, wherein the sending occurs during rendering of a web site hosted by the server.

3. The method according to claim 2, further comprising:
causing the web browser to associate the set of instructions with the web site and to store the set of instructions; and
subsequently sending updates to the set of instructions from the server to the web browser.

4. The method according to claim 1, further comprising communicating the set of the one or more URLs from the server to the web browser by specifying content to be placed in the context location.

5. The method according to claim 1, further comprising communicating the set of the one or more URLs from the server to the web browser through a hypertext markup language (HTML) tag specifying content to be placed in the context location.

6. The method according to claim 1, wherein the context location comprises a content menu.

7. The method according to claim 1, wherein the context location comprises a browser menu.

8. The method according to claim 1, wherein the context location comprises browser real estate, browser surface area and/or a browser container/canvas.

9. The method according to claim 1, wherein the context location is accessible by a user action.

10. The method according to claim 1, wherein the context location is right-click accessible.

11. The method according to claim 1, wherein the context location comprises a pull-down menu.

12. The method according to claim 1, wherein the set of instructions is a first set of instructions, the server is a first server and the set of the one or more URLs is a first set of the one or more URLs, the method further comprising:
sending a second set of instructions from a second server to a web browser;
causing the web browser to identify a second set of one or more universal resource locators (URLs) in the second set of instructions sent from the second server; and
causing the web browser to replace at least one of the first set of the one or more URLs with at least one of the second set of the one or more URLs in the context location.

13. The method according to claim 12, wherein the first server and the second server are incorporated in a shared device.

14. A machine-readable storage medium stored on a storage unit of a computing device and having executable instructions stored thereon, which, when executed, cause a processing unit of the computing device to execute the method of claim 1.

15. A method of operation of a web browser of a computing device, comprising:
sending a set of instructions from a server hosting a web site accessed by the web browser to the web browser such that the web browser identifies universal resource locators (URLs) along with information instances associated with each of the URLs; and
causing the web browser to define the information instances as being respectively associated with each of the URLs and to add the information instances as links to the URLs in a context location of the web browser, which is accessible in response to a command issued by a web browser user.

16. The method according to claim 15, wherein the causing of the web browser to add the information instances comprises causing the web browser to add the information instances as hyperlinks in the context location.

17. The method according to claim 15, further comprising causing the web browser to open a new web browser window accessing the URL of a clicked one of the linked information instances.

18. The method according to claim 15, further comprising causing the web browser to open a new web browser tab accessing the URL of a clicked one of the linked information instances.

19. A system, comprising:
a server having storage capacity on which a set of instructions are stored, which is configured to:
send the set of instructions to a web browser;
cause the web browser to identify a set of one or more universal resource locators (URLs) in the set of instructions; and
cause the web browser to add one or more of the identified set of the one or more URLs in a context location of the web browser.

20. The system according to claim 19, wherein the set of instructions is a first set of instructions, the server is a first server and the set of the one or more URLs is a first set of the one or more URLs, the system further comprising:
a second server having storage capacity on which a second set of instructions are stored, which is configured to:
send a second set of instructions to the web browser;
cause the web browser to identify a second set of one or more universal resource locators (URLs) in the second set of instructions; and
cause the web browser to replace at least one of the first set of the one or more URLs with at least one of the second set of the one or more URLs in the context location.
